(19) United States
(12) Patent Application Publication
(10) Pub. No.: US 2021/0023511 A1
(43) Pub. Date: Jan. 28, 2021

(54) LIQUID AERATION DEVICE AND METHOD

(71) Applicant: Rachel Spencer, Melbourne Beach, FL (US)

(72) Inventor: Rachel Spencer, Melbourne Beach, FL (US)

(21) Appl. No.: 16/917,973

(22) Filed: Jul. 1, 2020

Related U.S. Application Data
(60) Provisional application No. 62/876,939, filed on Jul. 22, 2019.

(51) Int. Cl. B01F 3/04; B01F 13/00

(52) U.S. Cl. CPC B01F 3/04248; B01F 2215/0072; B01F 13/002

(57) ABSTRACT

A liquid aeration device and method is provided that is configured for insertion into the mouth of a bottle of liquid which includes a battery powered impeller that strikes and aerates the liquid, as it is poured from the bottle. An optional inductive/wireless battery charging feature is also described which allows the aeration device to be recharged.

### FIELD OF THE INVENTION

The present invention relates to liquid aeration devices. More particularly, the present invention relates to an electrically powered liquid aeration device for use with liquids contained in a bottle.

### BACKGROUND OF THE INVENTION

The use of bottle pourers is known in the prior art. More specifically, bottle pourers are known to consist of a funnel like function, where the liquid is poured from a bottle through the funnel like device and into a receiving glass. There are many variations on this theme to use venturi geometric shape principles to introduce air into the liquid stream. Other conventional devices use shape surface geometry to increase the surface area of the funnel like device to increase the surface area of the liquid exposed to the air to increase the rate of oxidation of the liquid.

Other prior art devices include liquid pourers having spouts inserted into a bottle with hoses connected to the aerator for allowing air into the bottle. While these devices provide some benefits, there is a need for improved aerator assemblies usable with liquids, including consumable liquids such as wine, fruit, beverages, water, alcohol, spirits, or other beverages.

For example, U.S. patent application Ser. No. 13/800,390 to Prokop describes a battery powered motorized aerator device that is attached to the mouth of a wine bottle. The wine is aggressively aerated by a spinning propeller as the wine is poured from the bottle. However, this invention discloses a complicated drive mechanism where the propeller is belt driven and the motor and battery are placed in a large housing that sits on the outside of the bottle. In other words, the flow of the wine out of the bottle needs to be diverted by guides in the device to direct the flow of wine into the propeller as it spins. This results in a bulky and overly complicated device that is aesthetically unpleasing. In addition, the drive mechanism of the spinning propellers requires the use of a belt and pulley mechanism that is overly complicated, expensive, and prone to failures.

In another example, U.S. patent application Ser. No. 12/283,330 to Cheng discloses an electrically powered wine aeration device that is installed in the mouth of a typical wine bottle. An electric motor drives a shaft connected to wine blades and air blades to propel the wine flow and the airstream against each other to commingle the wine flow and the air stream inside the bottle. It should be noted that this invention DOES NOT provide a means to pour the wine out of the bottle while this device is inserted into the mouth of the bottle and further, the aeration of the wine DOES NOT occur while the wine is being poured from the bottle. The aeration of the wine occurs while it is retained in the bottle and the user must remove the device to pour the wine from the bottle.

Thus, there is a long-felt need to develop a new type of liquid aeration device that is simple to use, aesthetically pleasing, and allows a liquid such as wine to be aerated while it is being poured into the glass. There is also a further need for a liquid aeration device that is battery powered that is easily rechargeable for continued use.

It is therefore an object of the invention to provide an easy to use, aesthetically pleasing electrically powered aeration device that can be easily and quickly affixed to the mouth of a bottle for immediate aeration of a liquid as the liquid is being poured from the bottle.

### BRIEF DESCRIPTION OF THE DRAWINGS

Embodiments will be described with reference to the following drawing figures, in which like numerals represent like items throughout the figures, and in which:

FIG. 1 is an isometric view of a liquid aeration device in accordance with an exemplary embodiment of the invention.

FIG. 2 is an isometric close-up view of a liquid aeration device in accordance with an exemplary embodiment of the invention.

FIG. 3 is an isometric exploded view of a liquid aeration device in accordance with an exemplary embodiment of the invention.

FIG. 4 is an isometric section view of a liquid aeration device inserted into a typical bottle.

FIG. 5 is an electrical schematic of a liquid aeration device in accordance with an exemplary embodiment of the invention.

### DETAILED DESCRIPTION

The present invention is described with reference to the attached figures. The figures are not drawn to scale and they are provided merely to illustrate the invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

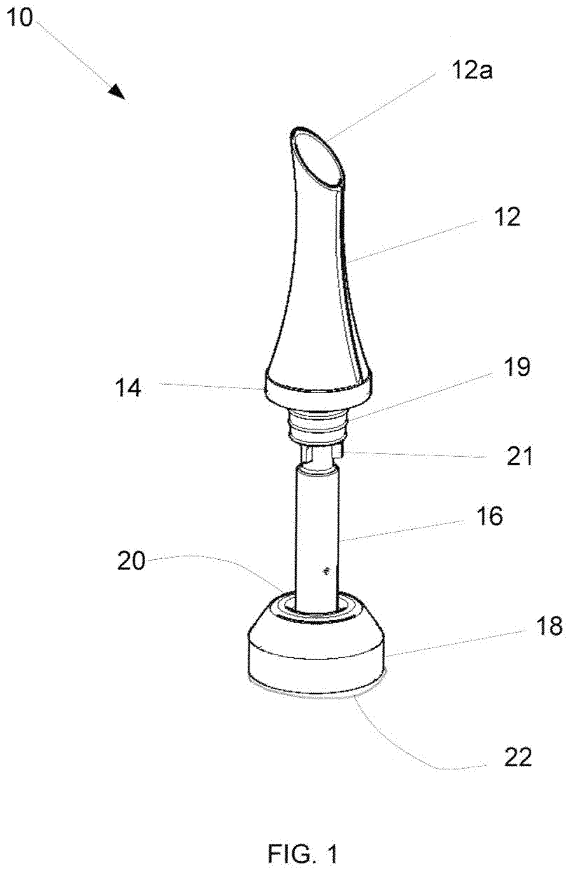

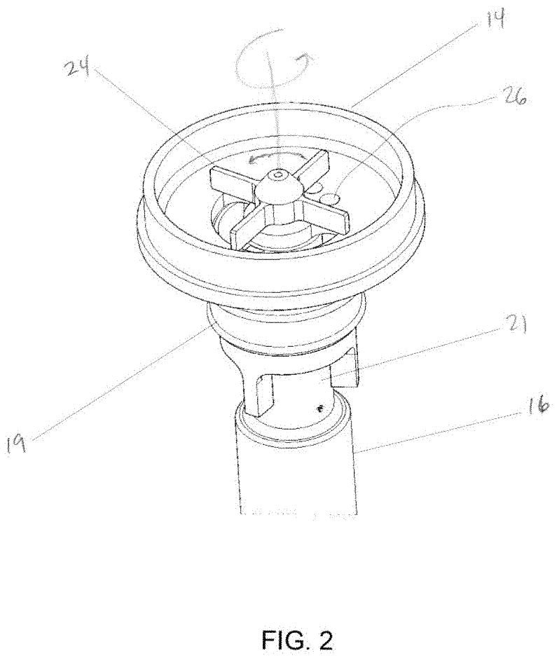

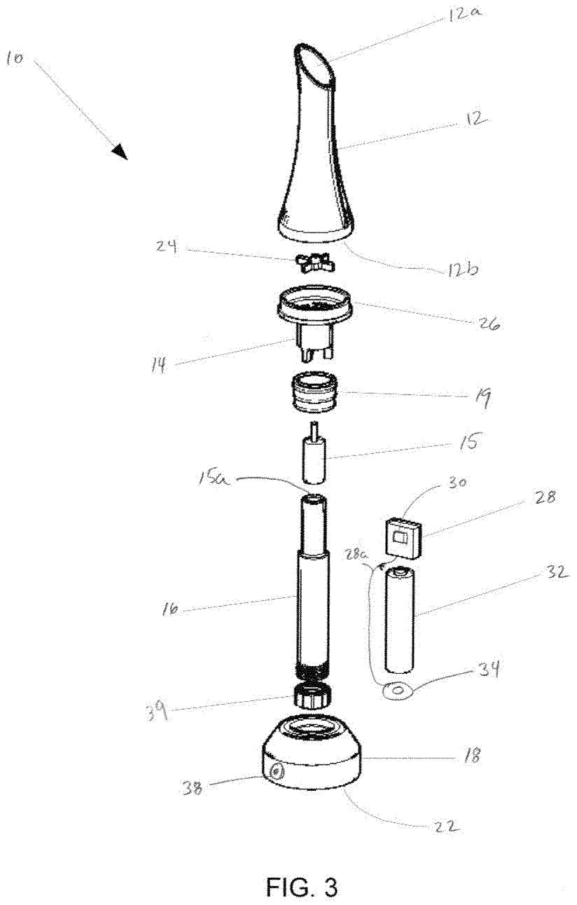

Referring now to FIGS. 1-5, where like numerals indicate like features, an exemplary electrically powered liquid aeration device 10 may be configured for removable insertion into the mouth of a typical bottle, such as for example a wine or liquor bottle 13. Located at the top distal end of the aeration device 10 may be a spout 12 that is configured to transfer the liquid from the bottle 13 to a glass or other container. At the distal ends of the spout 12 may be an exit 12a and entrance 12b which may be configured to allow the aerated liquid to easily transfer out of the spout 12 into a glass or other container. Affixed to the bottom distal end of the spout entrance 12b may be a cap 14 which is configured to cover the opening of the bottle 13 and allow the transfer of the liquid from the bottle 13 into the spout 12. A plurality of passageways 26 may be disposed in a top surface of the cap 14 to allow for the liquid to transfer from the bottle 13 in a controlled manner. An impeller 24 may be affixed to the shaft of an electric motor 15 such that it rotates at a high speed. The impeller 24 may be configured to rotate such that it strikes the liquid as it exits the bottle 13 through the passageways 26. The impeller 24 is configured to spray or diffuse the liquid against the interior Avails of the spout 12 as it rotates and thereby significantly increases the amount of liquid that is exposed to air. A person of skill in the art will quickly realize that myriad design configurations can be used for the shape and action of the impeller 24, all such variations are contemplated by this invention and the configuration of the impeller 24 as shown by the figures should not limit the scope of the invention.

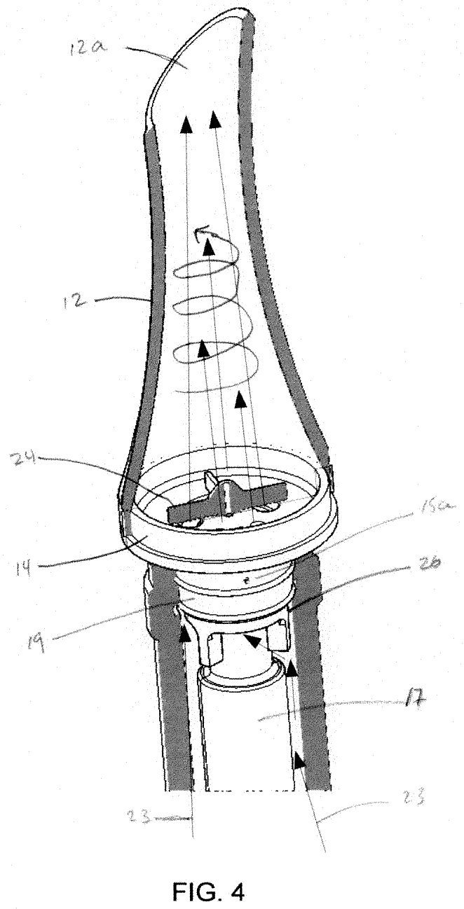

A central housing 16 may be affixed to the cap 14 and is sized to fit down into the mouth of the bottle 13 and reside in the mouth of the bottle 13 while being used. The central housing 16 may be comprised of an upper distal portion 15a where the electric motor 15 is coaxially disposed and retained; a sealing portion 19 that is configured to sealingly engage against the inside wall of the bottle 13 to prevent liquid from leaking from the bottle 13 while the liquid is being poured out of the bottle; an inlet portion 21 which allows the liquid to be directed from the bottle around the electric motor 15 and to the passageways 26 as shown by arrows 23 (FIG. 4); and, a co-axial internal cavity portion 17 where a battery 32, a receive recharging circuit 28 and a tilt switch 30 may be retained in a liquid tight cavity. Disposed at the lower distal end of the central housing 16 may be a removable cap 39. The tilt switch 30 is configured to allow voltage to flow from the battery 32 to the motor 15 only when the aeration device 10 is tipped to a predetermined angle which occurs as the liquid is being poured from a bottle. This therefore powers the spinning of the impeller 24 only when liquid is being transferred out of the bottle 13 and eliminates the need for a manual switch. Alternatively, the recharging circuitry just described could be replaced by a simple battery that may be replaced by the user when the battery runs out.

As can be seen from the description, the aeration device 10 has been configured so that impeller 24, motor 15, battery 32 and tilt switch 30 is all arranged and packaged in a co-axial fashion so that it may be inserted completely into the mouth of the bottle 13 which provides for an aesthetically pleasing and efficient means for aeration of a liquid as the liquid is poured from a bottle. This unique co-axial arrangement also allows for a low cost yet extremely reliable aeration device 10.

A charging base 18 may be provided that may be configured to removably retain the aeration device 10. The charging base 18 may comprise a receptacle portion 20 that is configured to removably engage the lower distal end of the central housing 16. A bottom cover 22 may be affixed to the bottom of the charging base 18. Disposed internally to the base 18 may be a transmit charging circuit 36 that is configured to wirelessly transmit an electrical charge to the receive recharging circuit 28 when the aeration device 10 is inserted into the charging base 18. A standard electrical connector 38 may be disposed on the charging base 18 and is in electrical communication with the transmit charging circuit 36. The charging base 18 is therefore configured to wirelessly charge the battery 32 that is disposed in the aeration device 10. As mentioned previously, it would be possible to eliminate the recharging circuitry and instead use a non-rechargable battery that can be replaced by the user.

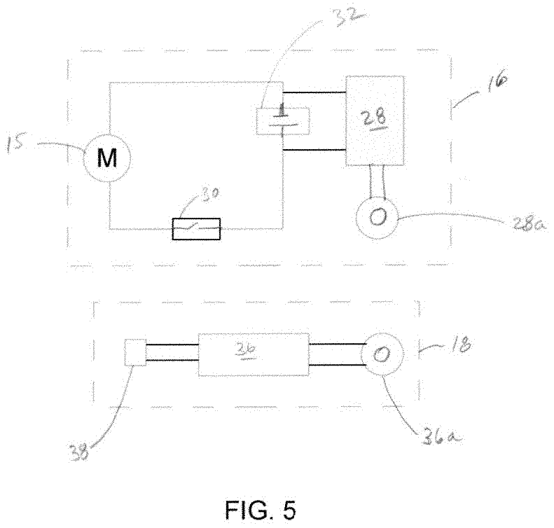

Referring now to FIG. 5, which shows the electrical schematic of the aeration device 10 and the charging base 18, the function of the recharging feature of the device will be described in more detail. In an exemplary embodiment, battery 32 is in electrical communication with the motor 15 via a tilt switch 30 m any well-known manner. In an exemplary embodiment of the invention, the battery 32 is a rechargeable lithium polymer or lithium ion battery with a DC voltage between 3-12 VDC. The motor 15 may be a coreless DC motor capable of 1,000-30,000 rpm rotational speed. The tilt switch 30 in an exemplary embodiment of the invention may be a ball type tilt switch that is configured to close the circuit when the device 10 is tipped about 45 degrees from the vertical axis so that it provides power to the motor 15 and starts the rotation of the impeller 24 as the bottle 13 is being tipped to pour the liquid.

The receive recharging circuit 28 is in electrical communication with the battery 32 and is configured to replenish the electrical charge in the battery 32. A receive coil 28a is connected to the recharging circuit 28 and allows for the inductive reception of energy from the transmit charging circuit 36. The receive coil 28a is disposed near the cap 34 of the aeration device 10. A transmit coil 36a is in electrical communication with the transmit charging circuit 36 and is disposed in the charging base 18 so that it may wirelessly transmit electrical energy to the receive coil 28a when the aeration 10 is inserted into the charging base 18. While an exemplary embodiment of the invention as described so far has been focused on a wireless/inductive method for recharging the battery, it would be possible to have a physical connection between the charging base 18 and the aeration device 10, this approach is fully contemplated by this invention. Alternatively, the battery could be a standard non-rechargable battery that is replaced when it no longer provides the necessary power.

What is claimed:

1. An electrically powered liquid aeration device comprising;
a main housing configured to retain internally an electrical power source, said main housing being inserted coaxially into the opening of a bottle;
a sealing portion disposed coaxially at a top distal end of said main housing, said sealing portion configured to sealingly engage the mouth of the bottle;
a motor in electrical communication with said electrical power source, said motor being disposed coaxially with said main housing;
an electrical switch in electrical communication between said motor and said electrical power source, wherein said switch is configured to turn said motor on and off; and,
an impeller configured to be rotatable by said motor, said impeller configured to aerate the liquid as it is poured from the bottle.

2. The electrically powered liquid aeration device of claim 1, wherein said electrical switch is a tilt type switch that is configured to control power to said motor based on the angular orientation of the bottle.

3. The electrically powered liquid aeration device of claim 1, wherein said electrical power source is a rechargable battery.

4. The electrically powered liquid aeration device of claim 3, further comprising:
a receive inductive charging circuit disposed internal to said main housing, said inductive charging circuit in electrical communication with said rechargeable battery;
a base configured to retain the aeration device when it is not inserted into a bottle;
a transmit recharging circuit disposed in said base, said transmit recharging circuit in wireless communication with said received inductive, said transmit recharging circuit configured to allow said rechargeable battery to be recharged.

5. The electrically powered liquid aeration device of claim 1, further comprising a spout disposed adjacent to said sealing member, said spout being configured to transfer the aerated fluid to a container.

6. A method for aerating a liquid as it is being poured from a bottle comprising the steps of:
placing an electric motor co-axially in the opening of the bottle;
affixing an impeller to said electric motor;
providing electrical power to said motor to cause the rapid rotation of said impeller; and,
directing the liquid into the path of said rapidly rotating impeller as the liquid is being poured from the bottle.

7. The method of claim 6, wherein the step of providing electrical power to the motor is performed by a tilt switch that is configured to energize the motor when the bottle is tilted.

8. The method of claim 6, further comprising the step of providing a recharge circuit in electrical communication with said electrical power, said recharge circuit being configured to recharge the electrical power.

9. An apparatus for aerating a fluid as it is being poured from a container comprising:
a cylindrical main housing configured to be inserted co-axially into the mouth of the container;
an electrical motor disposed at a top distal end of said main housing;
a sealing member disposed adjacent to said electrical motor, said sealing member being adapted to prevent the leakage of the fluid as the fluid is being poured from the container;
an impeller affixed to a shaft of said motor;
an electric power source disposed internal to said main housing, said power source be in electrical communication with said motor;
a spout affixed adjacent to a top distal end of said main housing; and,
wherein a plurality of passageways disposed adjacent to said impeller direct the flow of the liquid into the path of said impeller as the liquid is being poured from the container.

10. The apparatus of claim 9 further comprising a base configured to hold the apparatus when not inserted in a container.

11. The apparatus of claim 9 further comprising a removable cap disposed on a lower distal end of said main housing.

12. The apparatus of claim 9, wherein the electrical power source is one selected from the group consisting of a non-rechargable battery, a rechargeable battery and a capacitor.

13. The apparatus of claim 9 further comprising a tilt switch in electrical communication between said electrical power source and said motor, said tilt switch being configured to open and close the circuit between said power source and said motor based on the angular orientation of the container.

14. The apparatus of claim 9 further comprising an electrical switch configured to turn said motor off and on.

15. The apparatus of claim 15 wherein said electrical switch is comprised of a tilt type switch that is configured to turn said motor off and on based on the angular orientation of the container.
